(19) United States
(12) Patent Application Publication
(10) Pub. No.: US 2016/0345170 A1
(43) Pub. Date: Nov. 24, 2016

(54) WIRELESS NETWORK SEGMENTATION FOR INTERNET CONNECTED DEVICES USING DISPOSABLE AND LIMITED SECURITY KEYS AND DISPOSABLE PROXIES FOR MANAGEMENT

(71) Applicant: FTAC SYSTEMS, INC., Hollywood, FL (US)

(72) Inventor: Joshua MANN, Hollywood, FL (US)

(21) Appl. No.: 15/159,404

(22) Filed: May 19, 2016

Related U.S. Application Data
(60) Provisional application No. 62/165,053, filed on May 21, 2015.

(51) Int. Cl. H04W 12/04; H04W 12/08; H04L 29/06

(52) U.S. Cl. CPC H04W 12/04; H04L 63/061; H04L 63/0876; H04W 12/08

(57) ABSTRACT

A may create a security area within a network and a key for the security area. The processor may assign the key to a device. The processor may receive a request to connect to the security area from the device, the request comprising the key. The processor may determine whether the key is valid for the device. When the key is valid for the device, the processor may allow the at least one device to connect to the security area and associate the device with the security area so that the device can reconnect to the security area.

### CROSS REFERENCE TO RELATED APPLICATIONS

This application claims the benefit of U.S. Provisional Application No. 62/165,053, filed May 21, 2015 entitled “WIRELESS NETWORK SEGMENTATION FOR INTERNET CONNECTED DEVICES USING DISPOSABLE AND LIMITED SECURITY KEYS AND DISPOSABLE PROXIES FOR MANAGEMENT” which is hereby incorporated by reference in its entirety.

### BACKGROUND

Most connected devices and/or connected device hubs use Wi-Fi as a mechanism to connect to the internet and to their respective cloud services. The need for these devices to use Wi-Fi presents a unique security challenge for systems administrators and network owners. Existing means of securing devices require the user to set up a different wireless network, to have foreknowledge of the device, with information such as MAC address required. This foreknowledge makes it hard to control devices from being added to non-secure networks, as most users will follow the simplest pathway to adding a “connected device.” In addition, the use of RADIUS servers, while effective, requires complex setup, IT knowledge and the support of the “connected devices” themselves. By requiring users to have different wireless networks, and all this required information, it is expected that connected devices will be added to whatever network the user has the most information about. In addition to the foreknowledge problem, Wi-Fi networks also have security related issues in regards to a single key security model, in that even a secured Wireless network uses the same key for all devices that connect. In addition to the configuration complexity, having multiple named wireless networks increases the surface area of attack for each network. By creating dynamic segmentation of the networks and by only using a single SSID, an attacker would need to know the dynamically created key, and even then, would not be able to access the network if the number of key uses had been exhausted.

Justification

The method outlined in this document for securing connected devices creates a simplified mechanism for secure network segmentation. This method provides a localized data store and automatically creates network segmentation on a single wireless SSID. In addition, by using disposable access links for administration, the process allows for temporary access to these segmented networks. These methods may be used to secure edge sensor equipment, for example.

### DETAILED DESCRIPTION

The systems and methods described herein create an easy to use system that allows users and system administrators to automatically create secure network segmentation and security role assignment for their “Connected Devices” via a non-singular and disposable/controlled network passkey.

Using a device that implements this method for network segmentation may allow the customer to use a web based interface to create a single Wi-Fi network that will be used by all connected devices. This single wireless network (SWN) may use only a single Service Set Identifier (SSID), however it will not have a singular password for all devices. The SWN may have a disposable and/or restricted use limit for each network. Once the SWN is created, the user may then go into the web interfaces and create a network security area.

Network Security Areas:

Network security areas may be created by clicking “create a new security area” and then entering a unique WPA2 compatible network passkey. Should the end user know a predefined mac address, it can be input into the system to create an automatically generated passkey, based on a hash of the mac address itself. Only a single device can use each auto-generated passkey. In addition to the WPA2 passkey, the end user may be able to set the disposable/usage nature of the security area. The system may automatically assign a randomly generated VLAN ID, unless one is specified, to be used with that security area, so that the user does not need to specifically assign this. These VLAN assignments may remove the need for end users to create and manage individual VLAN configurations, unless they so choose. Each network area may use its own instance of DHCP for address assignment for the network assigned to it by the end user. During any period where no devices are connected to the particular network, the VLAN may be disabled, and upon an approved previously known device connecting, a new VLAN may be created. Should the end user not assign a specific subnet, the system may automatically assign a network that does not overlap with other areas or other system used subnets. Using this method, it may be possible for the system to support connection by devices using the secure areas method, as well as devices connected using traditional wireless security technologies, on other SSIDs of the system.

The user may be able to set the number of overall unique devices that can connect to the security area, which can be 1 or more, up to a global system limit. When a user configures the security area with the number of devices allowed, they may then be able to select a network IP address range and subnet for those devices. The network subnet mask may automatically be set to correspond with the number of allowed devices, which may be set by the user, unless the user chooses to override this. Once the key has been used for the predefined number of devices and/or the system limit, the key may no longer be usable. Once a key has been successfully used by a device, the device's MAC address and DHCP request fingerprint may be stored. Once a device is connected successfully, the system may learn that device into its list of Known Devices or “KD”. Each security zone may maintain a list of its associated KDs, and the system may maintain a master list of KDs. KD profiles for unique identification may include WPA Key, MAC address and DHCP clientid, and fingerprint. KDs may be allowed to reconnect to the network.

The user may also be able to set a network security area key expiration time period, which will tell the system when to stop accepting the defined key for any devices. The user may also be able to configure infrastructure related network settings, such as IP address range to be assigned via DHCP and enter pre-approved MAC addresses if desired. By default the system may provide Wi-Fi based network isolation for all devices connecting to the SWN. Once the security area has been created, a WPA key may be used as the SWN's identifier for all of the devices that need to join this specific network security area.

The end user may also benefit from the ability to easily move “known devices” from security area to security area once they have made a successful connection to the SWN. Known devices may be moved to new network security areas by using the web interface to access the list of known devices for any given security area, and then reassign it to another security area. The known device's information markers, MAC and fingerprint may be transferred to the new security area. A KD may only be attached to one security area at a time.

Management of Security Area Devices:

Once devices have been successfully added to a security area, the end user will need a way to connect to those devices and manage/configure them by having management devices connect to the security areas, or by initiating a management session. Connection/management may be provided in a way that does not create additional security liability (e.g., rather than simply connecting a computer or other device to the same network as the system to be managed).

In order to allow the end users to maintain the integrity of their security using this method, users may be given the ability to manage their devices which are connected to security areas, without having to modify the security area to allow additional connections. In order to allow the remote devices to be managed, but still maintain the integrity of the security areas, disposable and or dynamic proxy links may be used. A dynamic proxy link is a URL (Uniform Resource Identifier) or internet address that is used to connect to a remote device, but which is controlled by the system to expire after a certain number of uses or period of time. The dynamic proxy link may also represent a connection to a remote device that passes through a proxy server on the host server system that changes the source and destination port for communication.

A dynamic proxy link may be created by system users to allow temporary access to a device in a security area. To enable a dynamic link, the end user can go into the host system configuration menu and into a security zone, and then for a known device, select a “create the HTTP Link” option. This may allow the user to create a one-time or multi-use link which provides access to an HTTP based service on a remote device. When the link is generated, the user may be able to define the link properties, which may include the remote/local access rules, time to live/expire, number of uses, session timeout value of the link, and any source IP address or MAC address filters. These proxied links may also delete and no longer be accessible once they have exceeded the user defined use rules. When the link is accessed, the HTTP requests may be proxied to the correct network that the KD is located on.

For accessing devices that require management through additional protocols and not HTTP, the end-user may create a disposable port forward rule for the known device within a security area. A disposable port forward rule may allow the user to map a source and destination port firewall rule from an originating zone to a security zone, however, the user can apply multiple options for security to this rule. A disposable port forward rule may be created through the web interface under the security area and for each KD. If the user creates a disposable port forward rule, they may be asked what the destination port will be and/or the port range. Then they can input the source port or allow the system to generate a random port not in use on that network subnet. When the end user creates the disposable port forward rule, they may be able to define the properties, which may include the remote/local access settings, time to live/expire, number of uses, session timeout value of the rule, and any source IP address or MAC address filters The system in the background may track all connections to that port forward and delete it from use based on the user defined rules.

### Examples

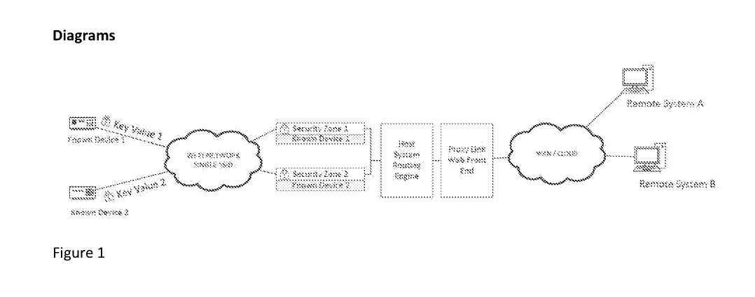

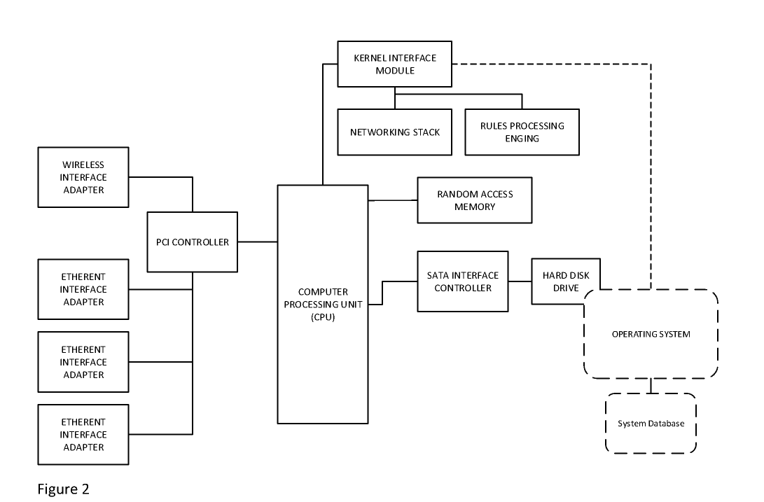

FIG. 1 shows an example network configured as described above. KD1 and KD2 are associated with key value 1 and key value 2, respectively, and connect to the SSID. Security zone 1 contains KD1, and security zone 2 contains KD2. The network areas, keys, KDs, etc. may be managed by the host system routing engine, described in greater detail in FIG. 2 below. Remote systems A and B connect via a WAN network to a dynamic proxy link web front end. Via the dynamic proxy link, managers on the remote systems may access the host system routing engine and manage KD1 and KD2.

FIG. 2 shows an example host system routing engine computer. The computer may be a special purpose computer configured to enable the network security area configuration and access described above. The computer may comprise a CPU, PCI controller, one or more wireless and/or wired (Ethernet) network adapters, hard drive interface controller and hard drive(s), memory, and/or other components. A kernel interface module may be provided for enabling processing of an operating system with system database access, a networking stack, and/or rules processing engine. The networking stack may configure the SWN as described above, and the rules processing engine may manage the devices connected to the SWN as described above.

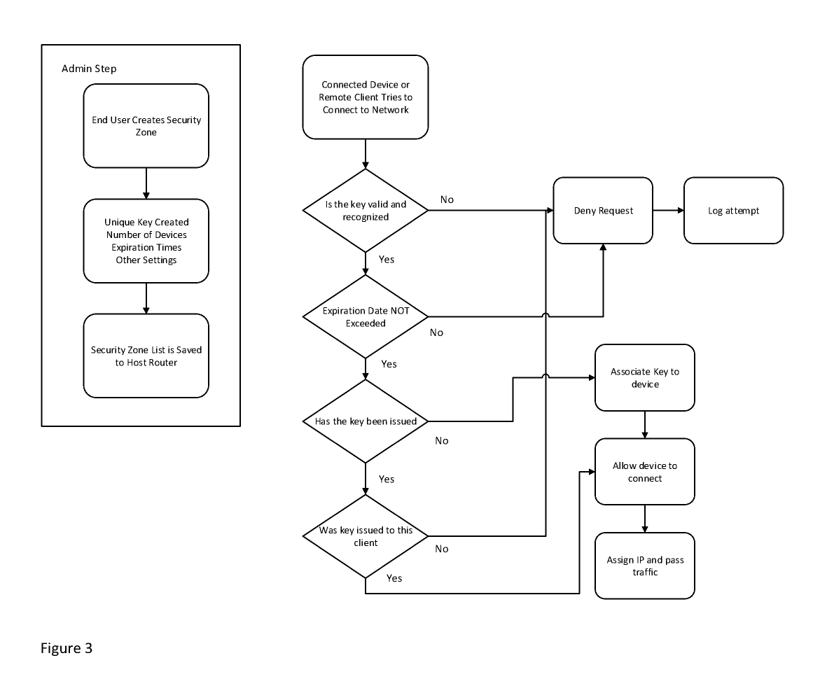

FIG. 3 shows examples of the processes described above. For example, in the admin step, the host system routing engine computer may receive a user definition of a security zone. Next, the host system routing engine computer may create a unique key for a device in the zone, along with the associated settings (e.g., access times, expiration, etc.). The security zone list may be saved to the host router for the zone.

FIG. 3 also shows an access process for the device. A remote client or device may try to connect to the SWN. If its key is not valid and recognized, the access request may be denied and the access attempt may be logged. If the key is valid and recognized, the expiration date of the key may be checked. If the key has expired, the access request may be denied and the access attempt may be logged. If the key has not expired, it may be determined whether the key has been issued. If not, the key may be associated with the device attempting to access the network. Then the device may be allowed to collect and assigned an IP address. If they key has been issued, it may be determined whether the key has been issued to the client attempting to use the key. If not, the access request may be denied and the access attempt may be logged. If the key is being used by the correct device, the device may be allowed to collect and assigned an IP address.

What is claimed is:

1. A method for connecting at least one device to a network comprising:
creating, with at least one processor, a security area within the network and a key for the security area;
assigning, with the processor, the key to the at least one device;
receiving, with the processor, a request to connect to the security area from the at least one device, the request comprising the key;
determining, with the processor, whether the key is valid for the at least one device;
when the key is valid for the at least one device, allowing, with the processor, the at least one device to connect to the security area; and
associating, with the processor, the at least one device with the security area so that the at least one device can reconnect to the security area.

2. The method of claim 1, wherein creating the security area comprises setting a number of devices that can connect to the security area, a network IP address range for connections to the security area, a subnet for the security area, or a combination thereof.

3. The method of claim 1, wherein creating the key comprises generating a key based on a predefined MAC address for the at least one device, generating a random key, or a combination thereof.

4. The method of claim 1, wherein assigning the key comprises setting a number of devices that can use the key, setting an expiration time for the key, or a combination thereof.

5. The method of claim 1, wherein assigning the key comprises distributing the key to the at least one device.

6. The method of claim 1, wherein determining whether the key is valid comprises recognizing the key, determining whether an expiration time for the key has been exceeded, determining whether the key has been issued to the at least one device, or a combination thereof.

7. The method of claim 1, further comprising when the key is not valid for the at least one device, denying the request, logging the request, or a combination thereof.

8. The method of claim 1, wherein associating the at least one device with the security area comprises storing the at least one device's MAC address, DHCP request fingerprint, DHCP client ID, key, or a combination thereof.

9. The method of claim 1, further comprising:
creating, with the processor, a dynamic link enabling temporary access to the at least one device via the network by a second device configured to change a setting of the at least one device; and
terminating, with the processor, the dynamic link.

10. The method of claim 1, further comprising:
creating, with the processor, a disposable port forward rule for the at least one device;
permitting, with the processor, a connection to the at least one device by a second device based on the disposable port forward rule; and
terminating, with the processor, the connection.

11. A system for connecting at least one device to a network comprising:
at least one memory; and
at least one processor in communication with the memory, the processor configured to:
create a security area within the network and a key for the security area;
assign the key to the at least one device;
receive a request to connect to the security area from the at least one device, the request comprising the key;
determine whether the key is valid for the at least one device;
when the key is valid for the at least one device, allow the at least one device to connect to the security area; and
associate the at least one device with the security area so that the at least one device can reconnect to the security area.

12. The system of claim 11, wherein creating the security area comprises:
setting a number of devices that can connect to the security area, a network IP address range for connections to the security area, a subnet for the security area, or a combination thereof; and
storing the setting in the memory.

13. The system of claim 11, wherein creating the key comprises:
generating a key based on a predefined MAC address for the at least one device, generating a random key, or a combination thereof; and
storing the key in the memory.

14. The system of claim 11, wherein assigning the key comprises:
setting a number of devices that can use the key, setting an expiration time for the key, or a combination thereof; and
storing the setting in the memory.

15. The system of claim 11, wherein assigning the key comprises distributing the key to the at least one device.

16. The system of claim 11, wherein determining whether the key is valid comprises recognizing the key, determining whether an expiration time for the key has been exceeded, determining whether the key has been issued to the at least one device, or a combination thereof.

17. The system of claim 11, wherein the processor is further configured to deny the request, log the request in the memory, or a combination thereof when the key is not valid for the at least one device.

18. The system of claim 11, wherein associating the at least one device with the security area comprises storing the at least one device's MAC address, DHCP request fingerprint, DHCP client ID, key, or a combination thereof in the memory.

19. The system of claim 11, wherein the processor is further configured to:
create a dynamic link enabling temporary access to the at least one device via the network by a second device configured to change a setting of the at least one device; and
terminate with the processor, the dynamic link.

20. The system of claim 11, wherein the processor is further configured to:
create a disposable port forward rule for the at least one device;
permit a connection to the at least one device by a second device based on the disposable port forward rule; and
terminate the connection.
